(19) United States
(12) Patent Application Publication
(10) Pub. No.: US 2026/0052448 A1
(43) Pub. Date: Feb. 19, 2026

(54) MOBILITY ENHANCEMENT IN WIRELESS COMMUNICATION SYSTEM

(71) Applicant: LG Electronics Inc., Seoul (KR)

(72) Inventors: Sunghoon JUNG, Seoul (KR); Sangwon KIM, Seoul (KR); Siyoung CHOI, Seoul (KR)

(21) Appl. No.: 19/101,792

(22) PCT Filed: Aug. 8, 2023
(86) PCT No.: PCT/KR2023/011683

§ 371 Date: Feb. 6, 2025

Related U.S. Application Data
(60) Provisional application No. 63/395,875, filed on Aug. 8, 2022.

(51) Int. Cl. H04W 36/36; H04W 36/00

(52) U.S. Cl. CPC H04W 36/362; H04W 36/00692; H04W 36/00835; H04W 36/00837

(57) ABSTRACT

The present disclosure relates to mobility enhancement in wireless communications. According to an embodiment of the present disclosure, a method performed by a user equipment (UE) in a wireless communication system comprises: receiving, from a first cell, a reference configuration for multiple cells and a plurality of modification configurations for the multiple cells, wherein each of the plurality of modification configurations is related to a corresponding cell; based on triggering a mobility from the first cell to a second cell among the multiple cells, identifying a modification configuration related to the second cell; and performing the mobility from the first cell to the second cell based on the reference configuration and the modification configuration related to the second cell.

### TECHNICAL FIELD

The present disclosure relates to mobility enhancement in wireless communications.

### BACKGROUND ART

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a user equipment (UE) may perform a mobility from a source cell to a target cell. For the mobility, the UE may be configured with one or more cell configurations, and may perform the mobility to a target cell based on applying a cell configuration for the target cell. Cell configuration for a target cell may be generated by applying a delta configuration to a cell configuration for the serving cell.

### DISCLOSURE OF INVENTION

### Solution to Problem

An aspect of the present disclosure is to provide method and apparatus for mobility enhancement in a wireless communication system.

Another aspect of the present disclosure is to provide method and apparatus for constructing cell configuration for mobility in a wireless communication system.

According to an embodiment of the present disclosure, a method performed by a user equipment (UE) in a wireless communication system comprises: receiving, from a first cell, a reference configuration for multiple cells and a plurality of modification configurations for the multiple cells, wherein each of the plurality of modification configurations is related to a corresponding cell; based on triggering a mobility from the first cell to a second cell among the multiple cells, identifying a modification configuration related to the second cell; and performing the mobility from the first cell to the second cell based on the reference configuration and the modification configuration related to the second cell.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: receiving, from a first cell, a reference configuration for multiple cells and a plurality of modification configurations for the multiple cells, wherein each of the plurality of modification configurations is related to a corresponding cell; based on triggering a mobility from the first cell to a second cell among the multiple cells, identifying a modification configuration related to the second cell; and performing the mobility from the first cell to the second cell based on the reference configuration and the modification configuration related to the second cell.

According to an embodiment of the present disclosure, a network node related to a first cell configured to operate in a wireless communication system comprises: at least one transceiver; at least one processor; and at least one memory operatively coupled to the at least one processor and storing instructions that, based on being executed by the at least one processor, perform operations comprising: generating a reference configuration for multiple cells and a plurality of modification configurations for the multiple cells, wherein each of the plurality of modification configurations is related to a corresponding cell; transmitting, to a user equipment (UE), a radio resource control (RRC) reconfiguration message comprising the reference configuration and the plurality of modification configurations; and receiving, from the UE, an RRC reconfiguration complete message as a response for the RRC reconfiguration message, wherein the UE is configured to: based on triggering a mobility from the first cell to a second cell among the multiple cells, identify a modification configuration related to the second cell; and perform the mobility from the first cell to the second cell based on the reference configuration and the modification configuration related to the second cell.

According to an embodiment of the present disclosure, a method performed by a network node related to a first cell configured to operate in a wireless communication system comprises: generating a reference configuration for multiple cells and a plurality of modification configurations for the multiple cells, wherein each of the plurality of modification configurations is related to a corresponding cell; transmitting, to a user equipment (UE), a radio resource control (RRC) reconfiguration message comprising the reference configuration and the plurality of modification configurations; and receiving, from the UE, an RRC reconfiguration complete message as a response for the RRC reconfiguration message, wherein the UE is configured to: based on triggering a mobility from the first cell to a second cell among the multiple cells, identify a modification configuration related to the second cell; and perform the mobility from the first cell to the second cell based on the reference configuration and the modification configuration related to the second cell.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: receiving, from a first cell, a reference configuration for multiple cells and a plurality of modification configurations for the multiple cells, wherein each of the plurality of modification configurations is related to a corresponding cell; based on triggering a mobility from the first cell to a second cell among the multiple cells, identifying a modification configuration related to the second cell; and performing the mobility from the first cell to the second cell based on the reference configuration and the modification configuration related to the second cell.

According to an embodiment of the present disclosure, a non-transitory computer readable medium (CRM) has stored thereon a program code implementing instructions that, based on being executed by at least one processor, perform operations comprising: receiving, from a first cell, a reference configuration for multiple cells and a plurality of modification configurations for the multiple cells, wherein each of the plurality of modification configurations is related to a corresponding cell; based on triggering a mobility from the first cell to a second cell among the multiple cells, identifying a modification configuration related to the second cell, and performing the mobility from the first cell to the second cell based on the reference configuration and the modification configuration related to the second cell.

The present disclosure may have various advantageous effects.

For example, the network can provide the UE with configurations for multiple candidate cells in a signaling-efficient way not only for upcoming mobility but also for subsequent mobility.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a legacy handover procedure to which technical features of the present disclosure can be applied.

FIG. 9 shows an example of a conditional handover procedure to which technical features of the present disclosure can be applied.

FIG. 10 shows an example of an MTRP based communication according to an embodiment of the present disclosure.

FIG. 11 shows an example of a potential serving cell configuration according to an embodiment of the present disclosure.

FIG. 12 shows an example of a method performed by a UE according to an embodiment of the present disclosure.

FIG. 13 show an example of a signal flow between UE and network node according to an embodiment of the present disclosure.

FIG. 14 shows an example of a method for a configuration adaptation associated with a mobility procedure according to an embodiment of the present disclosure.

FIG. 15 shows an example of configuration parameters for cells according to an embodiment of the present disclosure.

FIG. 16 shows an example of configuration parameters for cells before serving cell change according to an embodiment of the present disclosure.

FIG. 17 shows an example of configuration parameters for cells after serving cell change according to an embodiment of the present disclosure.

### MODE FOR THE INVENTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A. B or C” in the present disclosure may mean “only A”, “only B”, “only C”, or “any combination of A. B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B. C” may mean “A. B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A. B and C” may mean “only A”, “only B”, “only C”, or “any combination of A, B and C”. In addition, “at least one of A. B or C” or “at least one of A. B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

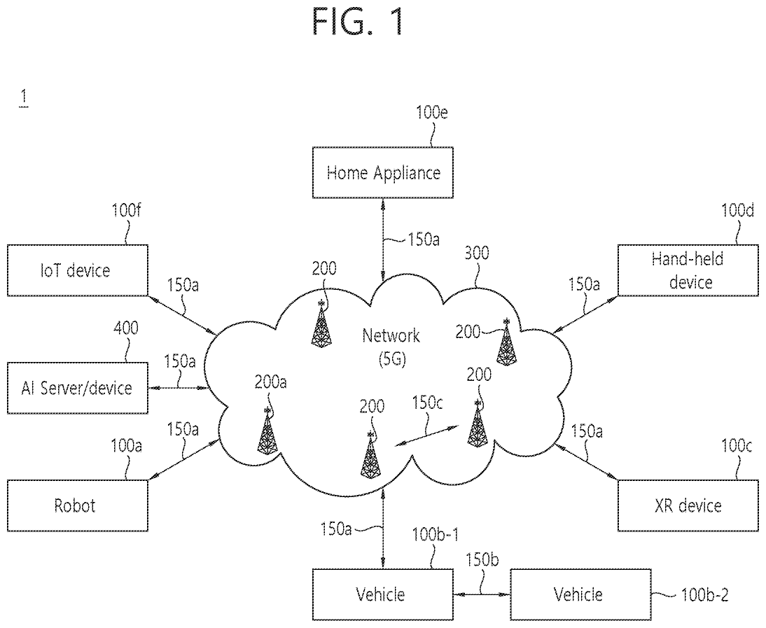

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system. FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

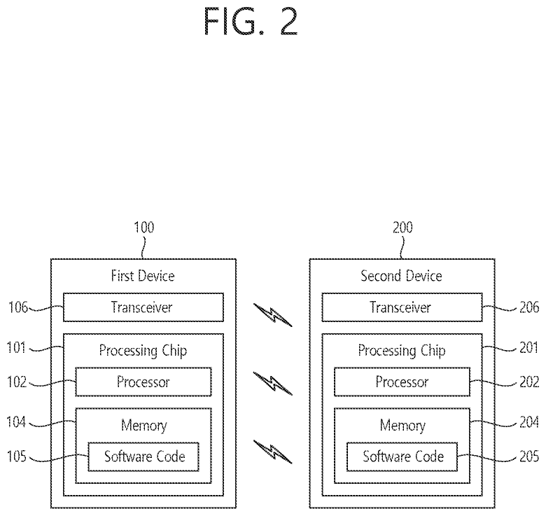

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer. Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM). Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 1M and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

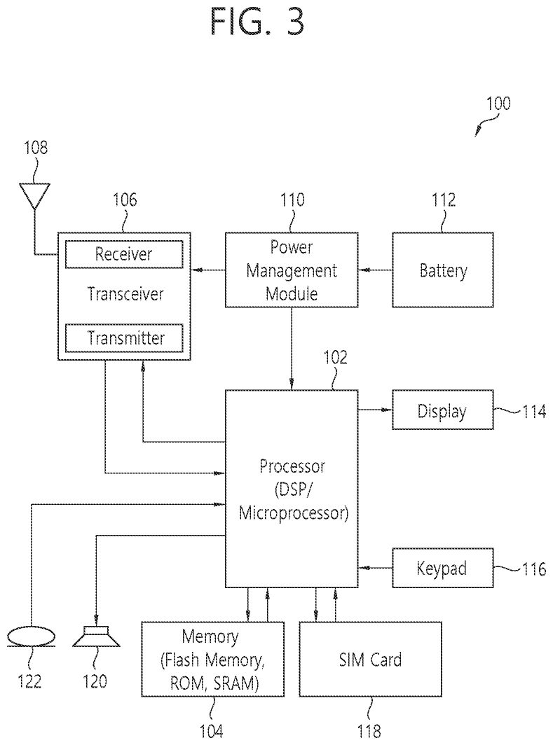

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU. GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

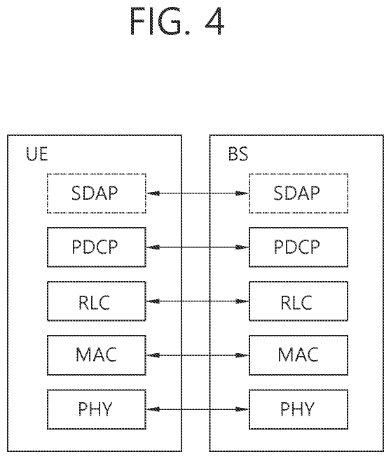

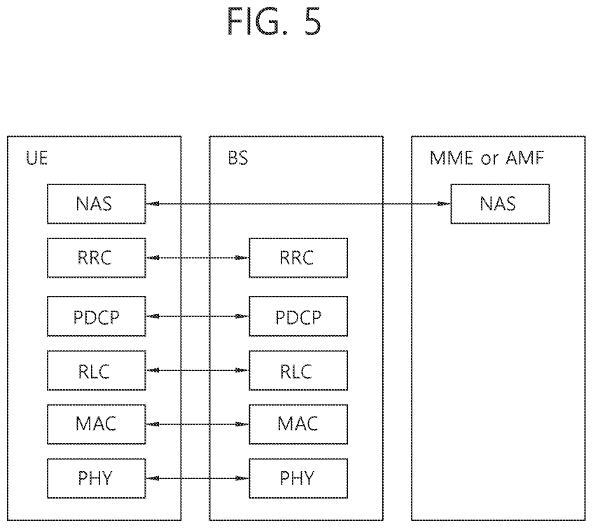

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)), priority handling between UEs by means of dynamic scheduling, priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

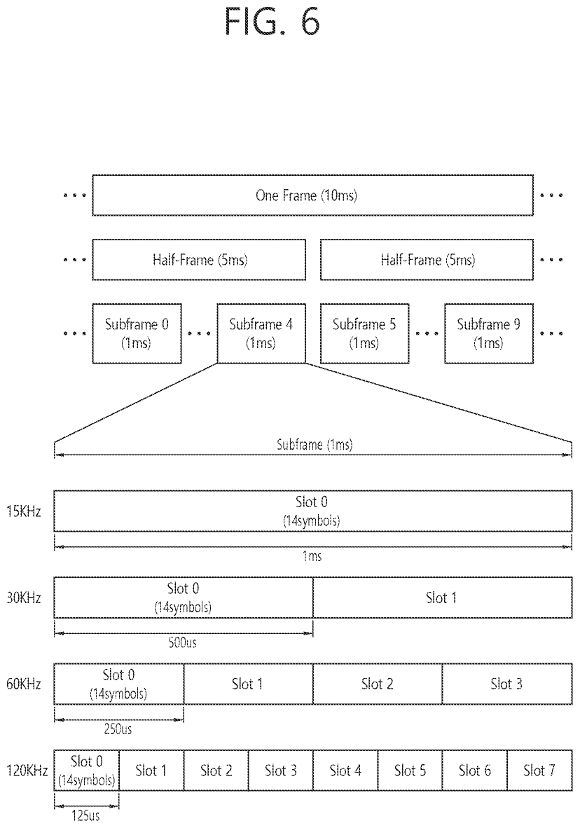

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is Ims. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ it for the normal CP, according to the subcarrier spacing βf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system. N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is Ims, which is the same as the subframe length. When SCS is 30 kHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 kHz. When SCS is 120 kHz, the slot length is 0.125 ms (=125 us), and the symbol length is half of that when the SCS is 60 kHz. When SCS is 240 kHz, the slot length is 0.0625 ms (=62.5 us), and the symbol length is half of that when the SCS is 120 kHz.

In the 3GPP NR system. RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

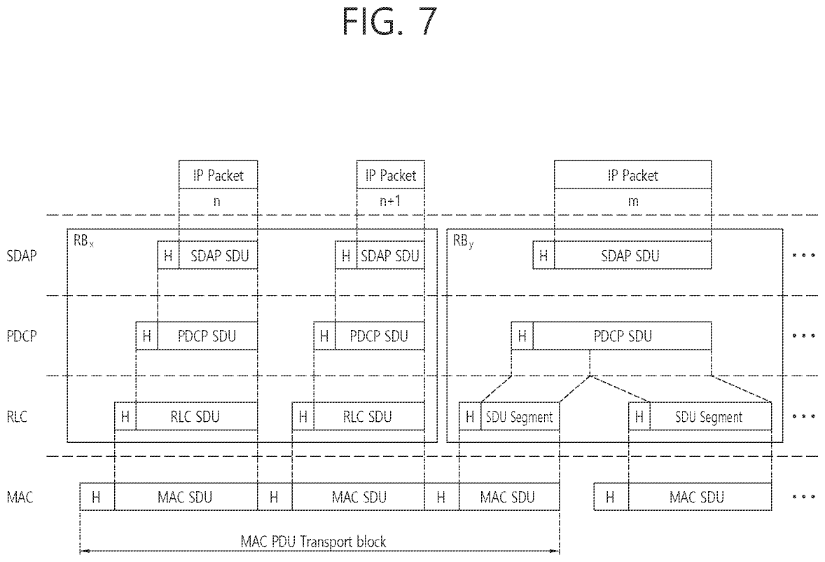

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, contents regarding handover (HO) are described.

The handover may comprise PCell change. Further, in the present disclosure, descriptions related to handover may also be applied to other mobility procedures, such as PSCell change (or, secondary node (SN) change) and/or PSCell addition (or, SN addition).

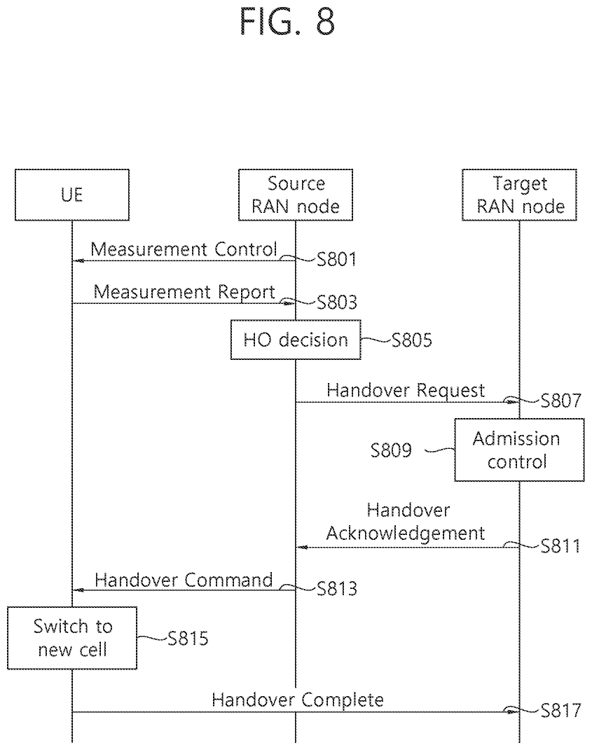

FIG. 8 shows an example of a legacy handover procedure to which technical features of the present disclosure can be applied.

Referring to FIG. 8, in step S801, the source RAN node may transmit measurement control message to the UE. The source RAN node may configure the UE measurement procedures according to the roaming and access restriction information and, for example, the available multiple frequency band information through the measurement control message. Measurement control information provided by the source RAN node through the measurement control message may assist the function controlling the UE's connection mobility. For example, the measurement control message may comprise measurement configuration and/or report configuration.

In step S803, the UE may transmit a measurement report message to the source RAN node. The measurement report message may comprise a result of measurement on neighbor cell(s) around the UE which can be detected by the UE. The UE may generate the measurement report message according to a measurement configuration and/or measurement control information in the measurement control message received in step S801.

In step S805, the source RAN node may make a handover (HO) decision based on the measurement report. For example, the source RAN node may make a HO decision and determine a target RAN node for HO among neighbor cells around the UE based on a result of measurement (e.g., cell quality, signal quality, signal strength, reference signal received power (RSRP), reference signal received quality (RSRP), channel state, channel quality, signal to interference plus noise ratio (SINR)) on the neighbor cells.

In step S807, the source RAN node may transmit a HO request message to the target RAN node which is determined in step S805. That is, the source RAN node may perform handover preparation with the target RAN node. The HO request message may comprise necessary information to prepare the handover at the target RAN node.

In step S809, the target RAN node may perform an admission control based on information included in the HO request message. The target RAN node may configure and reserve the required resources (e.g., C-RNTI and/or RACH preamble). The AS-configuration to be used in the target RAN node can either be specified independently (i.e. an “establishment”) or as a delta compared to the AS-configuration used in the source RAN node (i.e. a “reconfiguration”).

In step S811, the target RAN node may transmit a HO request acknowledge (ACK) message to the source RAN node. The HO request ACK message may comprise information on resources reserved and prepared for a handover. For example, the HO request ACK message may comprise a transparent container to be sent to the UE as an RRC message to perform the handover. The container may include a new C-RNTI, target gNB security algorithm identifiers for the selected security algorithms, a dedicated RACH preamble, and/or possibly some other parameters i.e. access parameters, SIBs. If RACH-less handover is configured, the container may include timing adjustment indication and optionally a preallocated uplink grant. The HO request ACK message may also include RNL/TNL information for forwarding tunnels, if necessary. As soon as the source RAN node receives the HO request ACK message, or as soon as the transmission of the handover command is initiated in the downlink, data forwarding may be initiated.

In step S813, the source RAN node may transmit a handover command, to the UE. For example, the handover command may comprise or may be a cell configuration (i.e., RRCReconfiguration message including the reconfigurationWithSync). The RRCReconfiguration message and/or reconfigurationWithSync for a target cell may comprise information required to access the target cell (i.e., access configuration) comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell. The source RAN node may perform the necessary integrity protection and ciphering of the message.

In step S815, the UE may switch to a new cell i.e., the target RAN node. The UE may detach from the old cell i.e., the source RAN node and synchronize to a new cell i.e., the target RAN node. The UE may perform a handover from the source RAN node to the target RAN node based on applying the cell configuration. For example, upon receiving the handover command, the UE may start the T304 timer, and perform a contention-free random access towards the target RAN node based on the set of dedicated RACH resources.

In step S817, upon successful completion of the random access procedure, the UE may stop the T304 timer, and transmit a handover complete message (i.e., RRCReconfigurationComplete message) to the target RAN node. The UE may send the RRCReconfigurationComplete message comprising the C-RNTI to confirm the handover, to the target RAN node to indicate that the handover procedure is completed for the UE. The target RAN node may verify the C-RNTI sent in the RRCReconfigurationComplete message. The target RAN node can now begin sending data to the UE. When the random access fails and the T304 timer is still running, the UE may retry random access towards the target RAN node. Upon expiry of the T304 timer, the UE may declare handover failure (HOF) and perform an RRC re-establishment procedure.

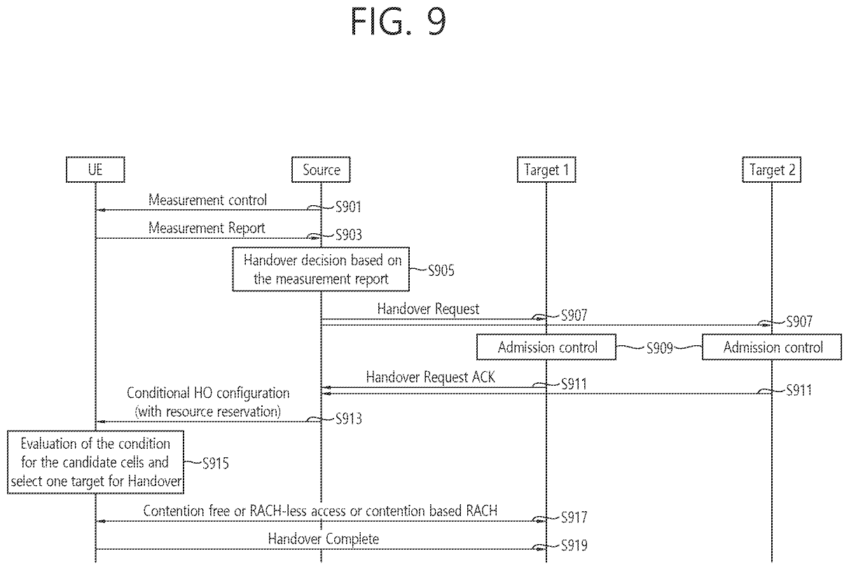

FIG. 9 shows an example of a conditional handover procedure to which technical features of the present disclosure can be applied.

Referring to FIG. 9, in step S901, the source cell may transmit measurement control message to the UE. The measurement control message may comprise a measurement configuration including a list of measurement configurations, and each measurement configuration in the list includes a measurement identity (ID), the corresponding measurement object and the corresponding report configuration.

In step S903, the UE may transmit a measurement report message to the source cell. The measurement report message may comprise a result of measurement on neighbor cell(s) around the UE which can be detected by the UE. The UE may generate the measurement report message according to a measurement configuration and/or measurement control information in the measurement control message received in step S901.

In step S905, the source cell may make a handover decision based on the measurement report. For example, the source cell may make a handover decision and determine candidate target cells (e.g., target cell 1 and target cell 2) for handover among neighbor cells around the UE based on a result of measurement (e.g., signal quality, reference signal received power (RSRP), reference signal received quality (RSRP)) on the neighbor cells.

In step S907, the source cell may transmit handover request messages to the target cell 1 and the target cell 2 which are determined in step S905. That is, the source cell may perform handover preparation with the target cell 1 and the target cell 2. The handover request message may comprise necessary information to prepare the handover at the target side (e.g., target cell 1 and target cell 2).

In step S909, each of the target cell 1 and the target cell 2 may perform an admission control based on information included in the handover request message. The target cell may configure and reserve the required resources (e.g., C-RNTI and/or RACH preamble). The AS-configuration to be used in the target cell can either be specified independently (i.e. an “establishment”) or as a delta compared to the AS-configuration used in the source cell (i.e. a “reconfiguration”).

In step S911, the target cell and the target cell 2 may transmit a handover request acknowledge (ACK) message to the source cell. The handover request ACK message may comprise cell configuration (i.e., RRCReconfiguration message including ReconfigurationWithSync) including information on resources reserved and prepared for a handover. For example, the handover request ACK message may comprise a transparent container to be sent to the UE as an RRC message (i.e., RRCReconfiguration message/cell configuration) to perform the handover. The container/cell configuration/RRCReconfiguration message may include information required to access the target cell (i.e., access configuration) comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell. If RACH-less handover is configured, the container may include timing adjustment indication and optionally a pre-allocated uplink grant. The handover request ACK message may also include RNL/TNL information for forwarding tunnels, if necessary. As soon as the source cell receives the handover request ACK message, or as soon as the transmission of the conditional handover command is initiated in the downlink, data forwarding may be initiated.

In step S913, the source cell may transmit a RRCReconfiguration message including a conditional reconfiguration to the UE. The conditional reconfiguration may be also referred to as (or, may comprise) conditional handover (CHO) configuration and/or a conditional handover command (e.g., CHO command). The conditional reconfiguration may comprise a list of conditional reconfigurations/conditional handover commands, including a conditional reconfiguration/conditional handover command for each of the candidate target cells (e.g., target cell 1, target cell 2). For example, the conditional reconfiguration may comprise a conditional reconfiguration/conditional handover command for the target cell 1, and a conditional reconfiguration/conditional handover command for the target cell 2. The conditional reconfiguration for a target cell may comprise an index/identifier identifying the corresponding conditional reconfiguration, a handover condition for the target cell, and/or a cell configuration (i.e., RRCReconfiguration message including the reconfigurationWithSync) for the target cell. The RRCReconfiguration message and/or reconfigurationWithSync for the target cell may comprise information required to access the target cell comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell.

In step S915, the UE may perform an evaluation of the handover condition for the candidate target cells (e.g., target cell 1, target cell 2) and select a target cell for a handover among the candidate target cells. For example, the UE may perform measurements on the candidate target cells, and determine whether a candidate target cell fulfils a handover condition for the candidate target cell among the candidate target cells based on a result of the measurements on the candidate target cells. Or, the UE may determine whether the target cell/measurement result for the target cell fulfils the handover condition of the target cell. If the UE identifies that the target cell 1 fulfils a handover condition for the target cell 1, the UE may select the target cell 1 as a target cell for the handover.

In step S917, the UE may detach from the old cell i.e., the source cell and synchronize to a new cell i.e., the selected target cell. The UE may perform a handover from the source cell to the target cell based on applying the cell configuration. For example, upon receiving the handover command, the UE may start the T304 timer, and perform a contention-free random access towards the target cell based on the set of dedicated RACH resources.

In step S919, upon successful completion of the random access procedure, the UE may stop the T304 timer, and transmit a handover complete message (i.e., RRCReconfigurationComplete message) to the target cell. The UE may send the RRCReconfigurationComplete message comprising the C-RNTI to confirm the handover, to the target cell to indicate that the handover procedure is completed for the UE. The target RAN node may verify the C-RNTI sent in the RRCReconfigurationComplete message. The target RAN node can now begin sending data to the UE. When the random access fails and the T304 timer is still running, the UE may retry random access towards the target cell. Upon expiry of the T304 timer, the UE may declare handover failure (HOF) and perform an RRC re-establishment procedure.

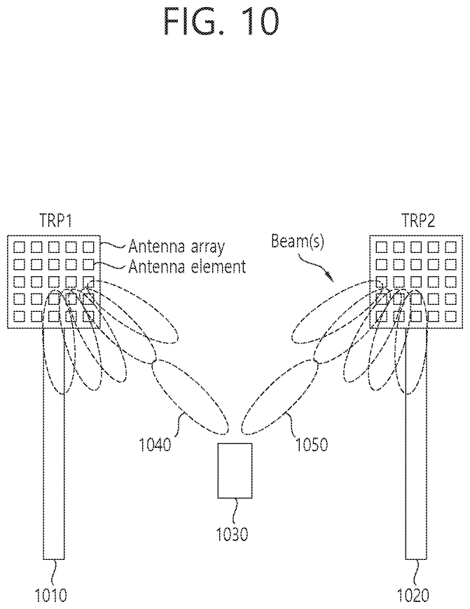

FIG. 10 shows an example of an MTRP based communication according to an embodiment of the present disclosure.

Referring to FIG. 10, UE 1030 is connected to a network via MTRP including TRP1 1010 and TRP2 1020. Each TRP may form a plurality of beams, and communicate with the UE 1030 via one or more of the plurality of beams. For example, TRP1 1010 may communicate with the UE 1030 via a beam 1040 among a plurality of beams formed by the TRP 1 1010, and TRP2 1020 may communicate with the UE 1030 via a beam 1050 among a plurality of beams formed by the TRP2 1020.

A beam may formed by a radiation from a plurality of antenna elements in an antenna array of a TRP. The antenna array and/or at least one antenna element may be related to one or more antenna ports. An antenna port may be defined such that the channel over which a symbol on the antenna port is conveyed can be inferred from the channel over which another symbol on the same antenna port is conveyed. That is, the antenna port is a logical concept, and the channel that is transmitted by a specific antenna port can be done by using a reference signal assigned for the specific antenna port. This means that each antenna port has its own reference signal.

The beam may be represented as a quasi co-location (QCL) information and/or a transmission configuration indication (TCI) state.

In an example, TRPs may be related to the same physical cell identifier (ID), but located in different geographical locations.

In an example, TRPs may be distinguished based on a control resource set (CORESET). That is, different TRPs may be associated with different CORESETs/CORESET IDs.

In an example, TRPs may be distinguished based on a TCI state. That is, different TRPs may be associated with different TCI states.

In an example, TRPs may be distinguished based on QCL information. That is, different TRPs may be associated with different QCL information.

In an example, TRPs may be distinguished based on a beam. That is, different TRPs may be associated with different beams.

### M-TRP (Multiple TRP) Transmission

In Multiple Transmit/Receive Point (multi-TRP) operation, a serving cell can schedule the UE from two TRPs, providing better coverage, reliability and/or data rates for PDSCH, PDCCH. PUSCH, and PUCCH.

There are two different operation modes to schedule multi-TRP PDSCH transmissions: single-DCI and multi-DCI. For both modes, control of uplink and downlink operation can be done by physical layer and MAC layer, within the configuration provided by the RRC layer. In single-DCI mode, the UE is scheduled by the same DCI for both TRPs and in multi-DCI mode, the UE is scheduled by independent DCis from each TRP.

There are two different operation modes for multi-TRP PDCCH: PDCCH repetition and SFN based PDCCH transmission. In both modes, the UE can receive two PDCCH transmissions, one from each TRP, carrying the same DCI. In PDCCH repetition mode, the UE can receive the two PDCCH transmissions carrying the same DCI from two linked search spaces each associated with a different CORESET. In SFN based PDCCH transmission mode, the UE can receive the two PDCCH transmissions carrying the same DCI from a single search space/CORESET using different TCI states.

For multi-TRP PUSCH repetition, according to indications in a single DCI or in a semi-static configured grant provided over RRC, the UE performs PUSCH transmission of the same contents toward two TRPs with corresponding beam directions associated with different spatial relations. For multi-TRP PUCCH repetition, the UE performs PUCCH transmission of the same contents toward two TRPs with corresponding beam directions associated with different spatial relations.

For inter-cell multi-TRP operation, for multi-DCI PDSCH transmission, one or more TCI states can be associated with SSB with a PCI different from the serving cell PCI. The activated TCI states can be associated with at most one PCI different from the serving cell PCI at a time.

The M-TRP transmission method in which M TRPs transmit data to one user equipment (UE) may comprise eMBB M-TRP transmission as a method to increase transmission rate, and/or transmission of URLLC M-TRP as a method for increasing reception success rate and reducing latency.

In addition, from the viewpoint of downlink control information (DCI) transmission, M-TRP (multiple TRP) transmission schemes may comprise i) M-DCI (multiple DCI) based M-TRP transmission in which each TRP transmits a different DCI, and/or ii) S-DCI (single DCI) based M-TRP transmission method in which one TRP transmits DCI. For example, in the case of S-DCI, since all scheduling information for data transmitted by M TRPs must be delivered through one DCI, it can be used in an ideal BH (ideal backhaul) environment in which dynamic cooperation between two TRPs is possible.

In the mTRP environment, the phases or roles of a plurality of TRPs associated with one cell may not be the same.

For example, the plurality of TRPs may be classified to primary-TRP (p-TRP) that receives/monitors essential system information and sends and receives key control information and secondary TRP (s-TRP) that increases the diversity effect through data boosting or redundant transmission of the same data as that of p-TRP.

For example, in UL transmission power allocation, p-TRP may allocate available power first, and s-TRP may allocate only remaining transmission power.

For example p-TRP may be a TRP using a signal/channel related to a physical cell ID obtained from PSS/SSS, and s-TRP may be a TRP using a signal/channel related to another PCI. In general, p-TRP is basically configured in one serving cell, and s-TRP associated with this serving cell may be optionally configured. When a s-TRP uses a serving cell resource, the s-TRP can be called intra-cell s-TRP. When a s-TRP uses a non-serving cell resource, the s-TRP can be called inter-cell s-TRP.

For example, a TRP that performs more accurate beam management by mainly performing BFD/RLM is defined as p-TRP, and a TRP configured to perform more relaxed BFD/RLM compared to BFD/RLM performed in p-TRP or not to perform BFD/RLM operation may be defined as s-TRP.

For example, in operating a serving cell related to multiple TRPs, the TRP used as the criterion for DL/UL synch of multiple TRPs is defined as p-TRP, and a TRP that matches DL/UL sync by applying an offset based on the synch timing of p-TRP can be defined as s-TRP.

In this way, if there is a difference between an operation performed in the p-TRP and an operation performed in the s-TRP, a difference between the p-TRP and the s-TRP may occur in data transmission/reception performance or reliability of a link. When the type of data to be transmitted by the UE is diverse and different types of data occur at different times, it may be optimal for the UE to select a TRP to be used for transmission of the data according to the type/characteristic of the data. For example, in the case of data requiring relatively high reliability/low latency, the UE may use p-TRP to increase the probability of satisfying the QoS requirements of the data, and for data requiring relatively low reliability/low latency, the UE may use s-TRP. Therefore, the UE can obtain an optimal trade-off in efficiency of multi-use TRP resources and satisfaction in transmission performance.

Meanwhile, if network wants to trigger mobility from a serving cell to another cell/target cell, network should provide target cell configuration (i.e., cell configuration for the target cell) to UE prior to initiation of the mobility.

In some mobility events, commonality between a source cell configuration and target cell configuration may be high. For example, consider the UE configured with a serving cell may be configured with two TRPs, where the serving cell provides a primary TRP (pTRP) resources and a neighbour cell provides a secondary TRP (sTRP) resources to the UE in some coordination with the serving cell. In case a mobility happens between the cell providing pTRP resources and the cell providing sTRPs, it would be beneficial to keep multi-TRP operations after the mobility. For instance, pTRP and sTRP may become sTRP and pTRP respectively after the mobility. To keep multi-TRP operations after mobility, network may have to provide the TRP-related configuration in mobility command. For the TRP-related configuration, network has to generate the TRP-related configuration with respect to the target cell as a new serving cell and provide the generated configuration to the UE.

In case mobility happens from the serving cell providing the pTRP resources (now source cell) to the neighbour cell providing the sTRP resources (now target cell), it would be beneficial to keep the multi-TRP operation in the target cell based on the previous TRP configuration used in the source cell, possibly with some configuration adaptation. More specifically, pTRP configuration used in the source cell may be used as a sTRP configuration in the target cell after the mobility, possibly with some adaptation to the configuration due to the role change from pTRP to sTRP. Likewise, sTRP configuration used in the source cell may be used as a pTRP configuration in the target cell after the mobility, possibly with some adaptation to the configuration due to the role change from sTRP to pTRP. That is, if the commonality properties of the configuration between the source and target are carefully exploited for such mobility events, the signalling involved in the mobility may be significant reduced, and interruption caused by the mobility may be also reduced. However, the current mechanism does not exploit the commonality properties.

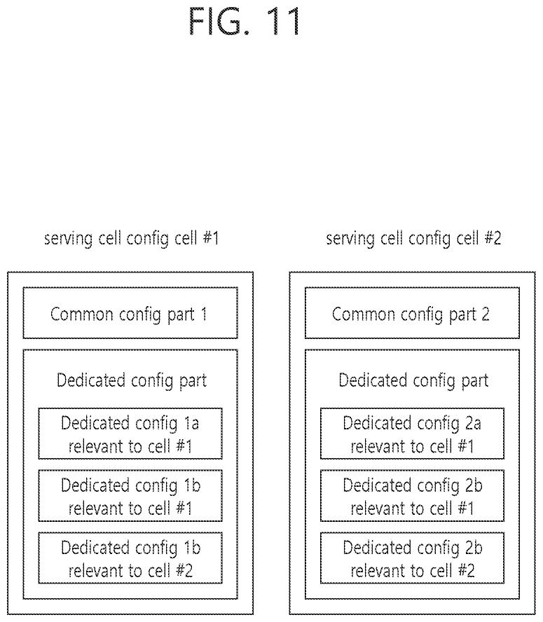

FIG. 11 shows an example of a potential serving cell configuration according to an embodiment of the present disclosure. In FIG. 11, cell #1 and cell #2 are serving cells.

In some implementations, some parts of the dedicated configuration of the serving cell configuration for cell #1 (dedicated config1b) may be related to both cell #1 and cell #2, and some parts of the dedicated configuration of the serving cell configuration for cell #2 (dedicated config2b) may be related to both cell #1 and cell #2, mTRP may be an example of such configurations, where i) cell #2 provides sTRP resources based on the dedicated config 1b when UE is configured with cell #1 as its serving cell providing pTRP resources based on the dedicated config 1b and ii) cell #1 provides sTRP resources based on the dedicated config 2b when UE is configured with cell #2 as its serving cell providing pTRP resources based on the dedicated config 2b. There is a high degree of commonality between the dedicated config1b and dedicated config2b, but they are not exactly the same.

Therefore, in this disclosure, a method for efficient configuration switching between a serving cell and a candidate/target cell based on non-shared configuration part and shared-configuration part with selective configuration adjustment is proposed.

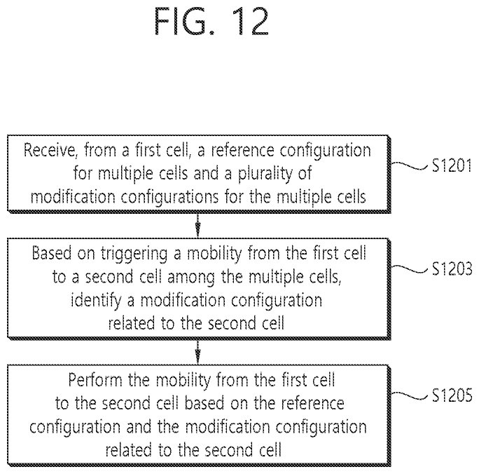

FIG. 12 shows an example of a method performed by a UE according to an embodiment of the present disclosure. The method may also be performed by a wireless device.

Referring to FIG. 12, in step S1201, UE may receive, from a first cell, a reference configuration for multiple cells and a plurality of modification configurations for the multiple cells. Each of the plurality of modification configurations may be related to a corresponding cell.

In step S1203, based on triggering a mobility from the first cell to a second cell among the multiple cells, the UE may identify a modification configuration related to the second cell.

In step S1205, the UE may perform the mobility from the first cell to the second cell based on the reference configuration and the modification configuration related to the second cell.

According to various embodiments, for performing of the mobility from the first cell to the second cell, the UE may construct a configuration for mobility to the second cell based on applying a modification configuration related to the second cell, to the reference configuration. The UE may apply the constructed configuration.

According to various embodiments, the configuration for mobility to the second cell may comprise a configuration for a cell associated with the second cell. The UE may identify, in the reconfiguration configuration for the multiple cells, a reference configuration part for the cell. The UE may identify, in the modification configuration related to the second cell, a modification configuration part for the cell. The UE may construct the configuration for the cell based on applying the modification configuration part for the cell to the reference configuration part for the cell.

According to various embodiments, each of the plurality of modification configurations related to the corresponding cell may comprise at least one of: a first modification configuration part that is applied based on the corresponding cell being a serving cell; or a second modification configuration part that is applied based on the corresponding cell being a non-serving cell.

According to various embodiments, after performing the mobility from the first cell to the second cell, the UE may store the reference configuration and the plurality of modification configurations in a list of configurations without releasing the reference configuration and the plurality of modification configurations. The stored reference configuration and the plurality modification configurations may be used for a subsequent mobility from the second cell to a third cell.

According to various embodiments, the UE may determine to store the reference configuration and each or all of the plurality of modification configurations in the list of configurations based on receiving an indication from a network. The plurality of modification configurations may comprise a modification configuration related to the first cell.

According to various embodiments, after performing the mobility from the first cell to the second cell, the UE may trigger a mobility from the second cell to the third cell among the multiple cells. The UE may identify, in the stored list of configurations, a modification configuration related to the third cell. The UE may perform the mobility from the second cell to the third cell based on the reference configuration and the modification configuration related to the third cell.

According to various embodiments, the reference configuration may be a first reference configuration related to a first group of cells. The UE may receive a second reference configuration related to a second group of cells.

According to various embodiments, after performing the mobility from the first cell to the second cell, the UE may trigger a mobility from the second cell to a third cell. The UE may determine whether the third cell belongs to the first group of cells or the second group of cells. Based on the third cell belonging to the first group of cells, the UE may perform the mobility from the second cell to the third cell based on the first reference configuration and a modification configuration related to the third cell. Based on the third cell belonging to the second group of cells, the UE may perform the mobility from the second cell to the third cell based on the second reference configuration and a modification configuration related to the third cell.

According to various embodiments, the mobility may comprise at least one of a primary cell (PCell) change, a primary secondary cell (PSCell) addition, a PSCell change, secondary cell (SCell) change, or a transmit/receive point (TRP) change.

According to various embodiments, the UE may trigger the mobility from the first cell to the second cell based on receiving a mobility indication from a network. The indication may be received via a radio resource control (RRC) signalling, a media access control (MAC) control element (CE) signalling, or downlink control information (DCI) on a physical downlink control channel (PDCCH).

According to various embodiments, the UE may trigger the mobility from the first cell to the second cell based a mobility condition for the second cell being satisfied. The mobility condition for the second cell may be included in the reference configuration or in the modification configuration related to the second cell or in a configuration associated with the modification configuration related to the second cell or in a current configuration outside the reference configuration.

According to various embodiments. UE may be configured with multiple configuration parts. Each configuration part may be associated with one or more cell. Each configuration part may include one or more adaptation configuration. UE may determine applicable parts of configuration based on the configuration parts and the current serving cell, possibly with configuration adjustment based on the configuration.

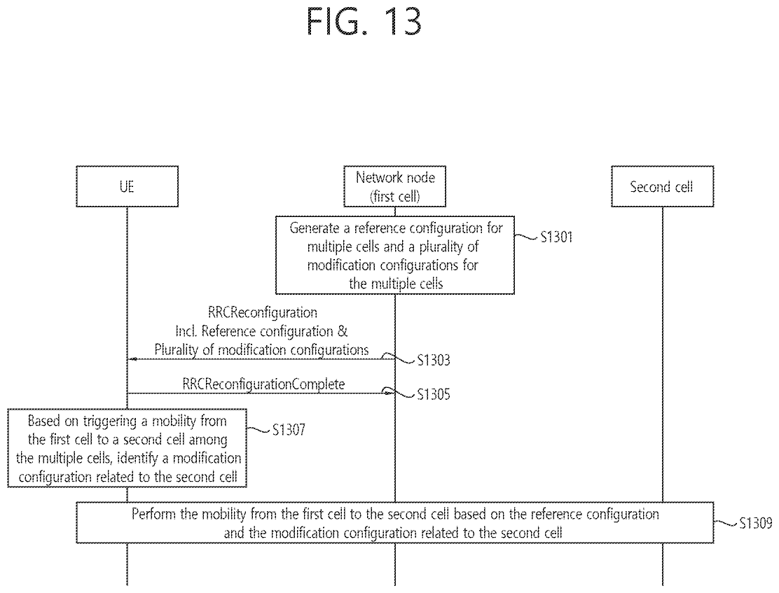

FIG. 13 show an example of a signal flow between UE and network node according to an embodiment of the present disclosure. The network node may comprise a base station (BS), and may be associated with a first cell.

Referring to FIG. 13, in step S1301, the network node may generate a reference configuration for multiple cells and a plurality of modification configurations for the multiple cells. Each of the plurality of modification configurations may be related to a corresponding cell.

In step S1303, the network node may transmit, to a UE, an RRC reconfiguration message comprising the reference configuration and the plurality of modification configurations.

In step S1305, the network node may receive, from the UE, an RRC reconfiguration complete message as a response for the RRC reconfiguration message.

In step S1307, based on triggering a mobility from the first cell to a second cell among the multiple cells, the UE may identify a modification configuration related to the second cell.

In step S1309, the UE may perform the mobility from the first cell to the second cell based on the reference configuration and the modification configuration related to the second cell.

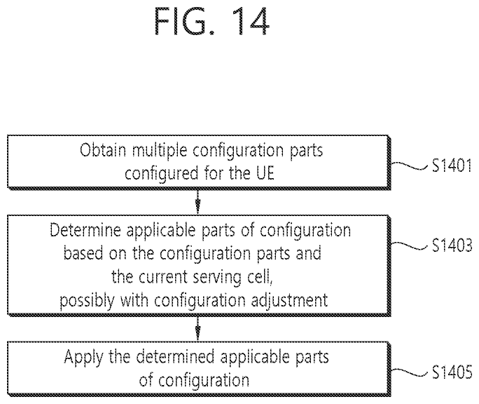

FIG. 14 shows an example of a method for a configuration adaptation associated with a mobility procedure according to an embodiment of the present disclosure. The method may be performed by a UE and/or a wireless device.

Referring to FIG. 14, in step S1401, the UE may obtain multiple configuration parts configured for the UE. For example, the UE may receive the multiple configuration parts from a network. The configuration part may be used to configure the reference configuration and/or the modification configurations.

Each configuration part may be associated with one or more cells. Each configuration part may be associated with one or more cell IDs (cell indexes or physical cell IDs (PCIs)).

At least one of the following configuration parts may be configured:
Non-shared common configuration part that is applicable only for the associated cell if the associated cell is a serving cell;
Non-shared common configuration part that is applicable only for the associated cell if the associated cell is a non-serving cell;
Non-shared dedicated configuration part that is applicable only for the associated cell if the associated cell is a serving cell;
Non-shared dedicated configuration part that is applicable only for the associated cell if the associated cell is a non-serving cell;
Shared-common configuration part that is applicable for multiple cells (applicable cells). Shared-common configuration part may have multiple shared-common configuration entries. For each of the applicable cells, one shared-common configuration entry may be associated and hence applied. For each of shared-common configuration entries, adjustment configuration may be also configured. Adjustment configuration may intend to adjust the corresponding shared-common configuration entry, depending on whether the applicable cell is a serving cell or non-serving cell. Adjustment configuration for serving cell and that for non-serving cell may be configured for the corresponding shared-common configuration entry.
Shared-dedicated configuration part that is applicable for multiple cells (applicable cells). Applicable cell of the concerned shared-dedicated configuration part may be implicitly indicated or explicated indicated. Shared-dedicated configuration part may have multiple shared-dedicated configuration entries. For each of the applicable cells, one shared-dedicated configuration entry may be associated and hence applied. For each of shared-dedicated configuration entries, adjustment configuration may be also configured. Adjustment configuration may intend to adjust the corresponding shared-dedicated configuration entry, depending on whether the applicable cell is a serving cell or non-serving cell. Adjustment configuration for serving cell and that for non-serving cell may be configured for the corresponding shared-dedicated configuration entry.

The shared configuration part may be used to configure the reference configuration. The non-shared configuration part may be used to configure the modification configuration.

In step S1403, UE may determine applicable parts of configuration based on the configuration parts and which cell is a serving cell, possibly with configuration adjustment. The UE may determine the applicable parts upon mobility to a target cell.

For each non-shared common configuration part that is applicable if the associated cell is a serving cell:
if the associated cell is a serving cell, UE may consider the configuration part as being active (i.e., the concerned configuration part is selected) or equivalently UE may activate the configuration part.
if the associated cell is not a serving cell, UE may consider the configuration part as being inactive (i.e., the concerned configuration part is not selected) or equivalently UE may deactivate the configuration part.

For each non-shared dedicated configuration part that is applicable if the associated cell is a serving cell:
if the associated cell is a serving cell, UE may consider the configuration part as being active (i.e., the concerned configuration part is selected) or equivalently UE may activate the configuration part.
if the associated cell is not a serving cell, UE may consider the configuration part as being inactive (i.e., the concerned configuration part is not selected) or equivalently UE may deactivate the configuration part.

For each non-shared common configuration part that is applicable if the associated cell is a not serving cell:
if the associated cell is a not serving cell, UE may consider the configuration part as being active (i.e., the concerned configuration part is selected) or equivalently UE may activate the configuration part.
if the associated cell is a serving cell, UE may consider the configuration part as being inactive (i.e., the concerned configuration part is not selected) or equivalently UE may deactivate the configuration part.

For each non-shared dedicated configuration part that is applicable if the associated cell is not a serving cell:
if the associated cell is not a serving cell, UE may consider the configuration part as being active (i.e., the concerned configuration part is selected) or equivalently UE may activate the configuration part.
if the associated cell is a serving cell. UE may consider the configuration part as being inactive (i.e., the concerned configuration part is not selected) or equivalently UE may deactivate the configuration part.

For each shared-common configuration part, UE may select a shared-common configuration entry applicable for the serving cell and that for the other cell, based on the association relation between the shared-common configuration entries and applicable cells, possibly with configuration adjustment.

For each shared-dedicated configuration part. UE may select a shared-dedicated configuration entry applicable for the serving cell and that for other cell, based on the association relation between the shared-dedicated configuration entries and applicable cells, possibly with adjustment.

In step S1405, the UE may apply the determined applicable parts of configuration. The UE may apply the determined applicable parts upon mobility to a target cell.

UE may be configured with an explicit indicator indicating whether the concerned configuration part can remain inactive (or can enter deactivated) without being released when the associated PCI becomes a non-serving cell or whether the concerned configuration part should be released. UE may be configured with an explicit indicator indicating whether the concerned configuration part can remain active at least partly with a role change (via adaptation) when the associated PCI becomes a non-serving cell. The indicator can be configured when network configures the UE with the configuration parts or when providing mobility command.

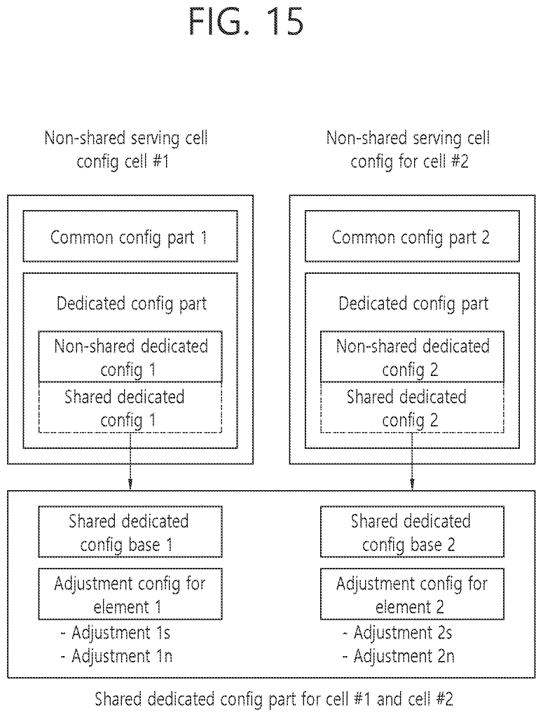

FIG. 15 shows an example of configuration parameters for cells according to an embodiment of the present disclosure.

Referring to FIG. 15, UE may be configured with configuration parameters for cell 1 and cell2. UE may be configured with non-shared serving cell configuration part for cell1 applicable only when the cell1 is a serving cell, and UE may also be configured with non-shared serving cell configuration part for cell2 applicable only when the cell2 is a serving cell, and shared-dedicated configuration part commonly applicable for cell1 and cell2 (i.e., applicable when cell1 is a serving cell and also when cell2 is a serving cell).

The shared-dedicated configuration part may include shared-dedicated configuration base1 applicable for cell1 and shared-dedicated configuration base2 applicable for the cell2. The shared-dedicated configuration part may include a shared-dedicated configuration base applicable for cell1 and the cell2. For the shared-dedicated configuration part, adjustment configuration part may also be configured. The adjustment configuration part may include adjustment configuration for cell1 and adjustment configuration for cell2.

The adjustment configuration for cell 1 may include adjustment_1s that is used to adjust the shared-dedicated configuration base1 when the cell1 is a serving cell. The adjustment configuration for cell1 may include adjustment_1n that is used to adjust the shared-dedicated configuration base1 when the cell1 is a non-serving cell.

The adjustment configuration for cell2 may include adjustment_2s that is used to adjust the shared-dedicated configuration base2 when the cell2 is a serving cell. The adjustment configuration for cell2 may include adjustment_2n that is used to adjust the shared-dedicated configuration base2 when the cell2 is a non-serving cell.

For example, the reference configuration for cell #1 and cell #2 may comprise at least one of shared-dedicated configuration base1 or shared-dedicated configuration base2.

The modification configuration for cell #1 may comprise at least one of a modification configuration for serving cell related to cell #1 and a modification configuration for non-serving cell related to cell #1. The modification configuration for serving cell related to cell #1 may comprise at least one of common configuration part 1, non-shared dedicated configuration 1, or adjustment_1s. The modification configuration for non-serving cell related to cell #1 may comprise adjustment_1n.

The modification configuration for cell #2 may comprise at least one of a modification configuration for serving cell related to cell #2 and a modification configuration for non-serving cell related to cell #2. The modification configuration for serving cell related to cell #2 may comprise at least one of common configuration part 2, non-shared dedicated configuration 2, or adjustment_2s. The modification configuration for non-serving cell related to cell #2 may comprise adjustment_2n.

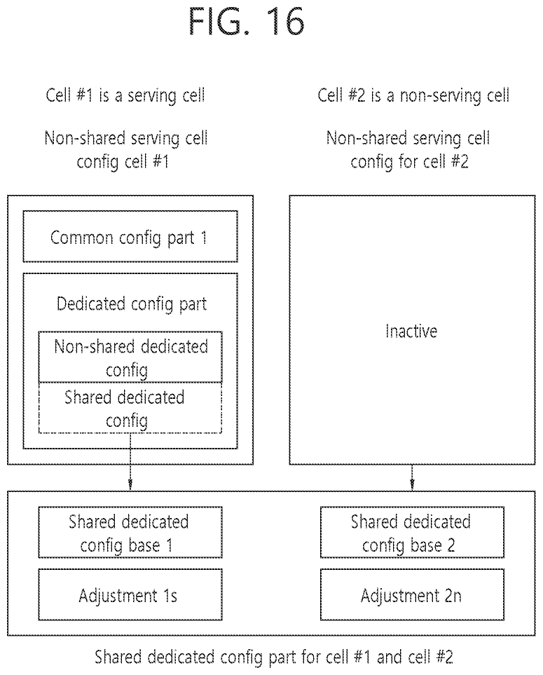

FIG. 16 shows an example of configuration parameters for cells before serving cell change according to an embodiment of the present disclosure.

Referring to FIG. 16, cell #1 may be configured as a serving cell to the UE. Cell #2 may be configured as a non-serving cell, e.g., candidate cell to possibly become a serving cell.

UE may activate the non-shared serving cell configuration part for cell1. UE may deactivate the non-shared serving cell configuration part for cell2.

UE may activate the shared-dedicated configuration part with adjustments, where UE adjusts the shared-dedicated configuration base1 based on the adjustment_1s and also adjusts the shared-dedicated configuration base2 based on the adjustment_2n. Then UE may apply the activated configuration parts as a serving cell configuration.

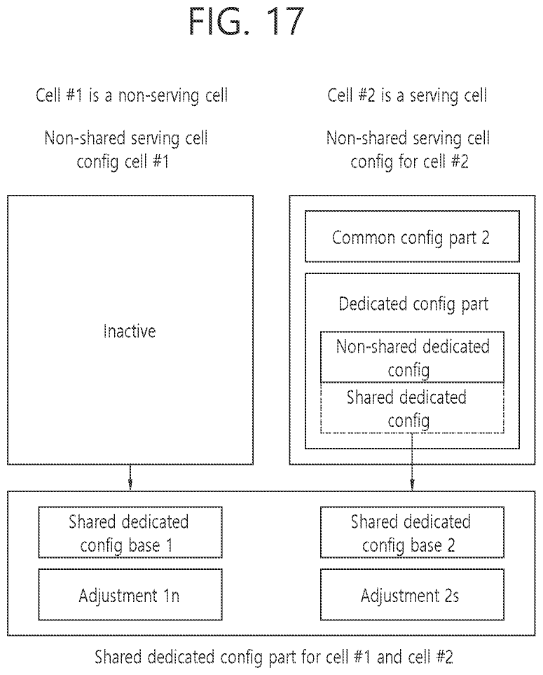

FIG. 17 shows an example of configuration parameters for cells after serving cell change according to an embodiment of the present disclosure.

Referring to FIG. 17, cell #2 may become a serving cell due to mobility or change of a serving cell.

UE may activate the non-shared serving cell configuration part for cell2. UE may deactivate the non-shared serving cell configuration part for cell1.

UE may activate the shared-dedicated configuration part with adjustments, where UE adjusts the shared-dedicated configuration base1 based on the adjustment_1n and also adjusts the shared-dedicated configuration base2 based on the adjustment_2s. Then UE may apply the activated configuration parts as a serving cell configuration.

Furthermore, the method in perspective of the UE described in the present disclosure (e.g., in FIG. 12) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving, from a first cell, a reference configuration for multiple cells and a plurality of modification configurations for the multiple cells, wherein each of the plurality of modification configurations is related to a corresponding cell; based on triggering a mobility from the first cell to a second cell among the multiple cells, identifying a modification configuration related to the second cell; and performing the mobility from the first cell to the second cell based on the reference configuration and the modification configuration related to the second cell.

Furthermore, the method in perspective of the UE described in the present disclosure (e.g., in FIG. 12) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving, from a first cell, a reference configuration for multiple cells and a plurality of modification configurations for the multiple cells, wherein each of the plurality of modification configurations is related to a corresponding cell; based on triggering a mobility from the first cell to a second cell among the multiple cells, identifying a modification configuration related to the second cell; and performing the mobility from the first cell to the second cell based on the reference configuration and the modification configuration related to the second cell.

Furthermore, the method in perspective of the UE described in the present disclosure (e.g., in FIG. 12) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving, from a first cell, a reference configuration for multiple cells and a plurality of modification configurations for the multiple cells, wherein each of the plurality of modification configurations is related to a corresponding cell; based on triggering a mobility from the first cell to a second cell among the multiple cells, identifying a modification configuration related to the second cell; and performing the mobility from the first cell to the second cell based on the reference configuration and the modification configuration related to the second cell.

Furthermore, the method in perspective of a network node related to a first cell described in the present disclosure (e.g., in FIG. 13) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: generating a reference configuration for multiple cells and a plurality of modification configurations for the multiple cells, wherein each of the plurality of modification configurations is related to a corresponding cell; transmitting, to a user equipment (UE), a radio resource control (RRC) reconfiguration message comprising the reference configuration and the plurality of modification configurations; and receiving, from the UE, an RRC reconfiguration complete message as a response for the RRC reconfiguration message, wherein the UE is configured to: based on triggering a mobility from the first cell to a second cell among the multiple cells, identify a modification configuration related to the second cell; and perform the mobility from the first cell to the second cell based on the reference configuration and the modification configuration related to the second cell.

The present disclosure may have various advantageous effects.

For example, the network can provide the UE with configurations for multiple candidate cells in a signaling-efficient way not only for upcoming mobility but also for subsequent mobility.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving a reference configuration for multiple cells and a plurality of modification configurations for the multiple cells, wherein each of the plurality of modification configurations is related to a corresponding cell;
detecting that a mobility to a first cell among the multiple cells is triggered; and
applying a configuration of the first cell based on the mobility to the first cell being triggered,
wherein the configuration of the first cell is generated by applying a modification configuration for the first cell among the plurality of modification configurations on the reference configuration.

2. (canceled)

3. The method of claim 1, further comprising:
identifying, in the reference configuration for the multiple cells, a reference configuration part for the first cell;
identifying, in the modification configuration for the first cell, a modification configuration part for the first cell; and
generating the configuration gf the first cell by applying the modification configuration part for the first cell on the reference configuration part for the first cell.

4. The method of claim 1, wherein each of the plurality of modification configurations related to the corresponding cell comprises at least one of:
a first modification configuration part that is applied based on the corresponding cell being a serving cell; or
a second modification configuration part that is applied based on the corresponding cell being a non-serving cell.

5. The method of claim 1, after performing the mobility to the first cell, further comprising:
storing the reference configuration and the plurality of modification configurations in a list of configurations without releasing the reference configuration and the plurality of modification configurations.

6. The method of claim 5, further comprising:
determining to store the reference configuration and one or more of the plurality of modification configurations in the list of configurations based on receiving an indication from a network,
wherein the plurality of modification configurations comprise a modification configuration related to a second cell from which the mobility to the first cell is triggered.

7. The method of claim 5, after performing the mobility to the first cell, further comprising:
triggering a mobility from the first cell to a third cell among the multiple cells;
identifying, in the stored list of configurations, a modification configuration related to the third cell; and
performing the mobility from the first cell to the third cell based on the reference configuration and the modification configuration related to the third cell.

8. The method of claim 1, wherein the reference configuration is a first reference configuration related to a first group of cells, and
wherein the method further comprises receiving a second reference configuration related to a second group of cells.

9. The method of claim 8, after performing the mobility to the first cell, further comprising:
triggering a mobility from the first, cell to a third cell;
determining whether the third cell belongs to the first group of cells or the second group of cells;
based on the third cell belonging to the first group of cells, performing the mobility from the first cell to the third cell based on the first reference configuration and a modification configuration related to the third cell; and
based on the third cell belonging to the second group of cells, performing the mobility from the first cell to the third cell based on the second reference configuration and a modification configuration related to the third cell.

10. The method of claim 1, wherein the mobility comprises at least one of a primary cell (PCell) change, a primary secondary cell (PSCell) addition, a PSCell change, secondary cell (SCell) change, or a transmit/receive point (TRP) change.

11. The method of claim 1, further comprising:
triggering the mobility to the first cell based on receiving a mobility indication from a network,
wherein the indication is received via a radio resource control (RRC) signalling, a media access control (MAC) control element (CE) signalling, or downlink control information (DCI) on a physical downlink control channel (PDCCH).

12. The method of claim 1, further comprising:
triggering the mobility to the first cell based a mobility condition for the first cell being satisfied,
wherein the mobility condition for the first cell is included in the reference configuration or in the modification configuration related to the first cell or in a configuration associated with the modification configuration related to the first cell or in a current configuration outside the reference configuration.

13. The method of claim 1, wherein the method is performed by a user equipment (UE) in communication with at least one of a mobile device, a network, or autonomous vehicles.

14. A user equipment (UE) comprising:
at least one transceiver;
at least one processor; and
at least one memory operatively coupled to the at least one processor and storing instructions that, based on being executed by the at least one processor, perform operations comprising:
receiving a reference configuration for multiple cells and a plurality of modification configurations for the multiple cells, wherein each of the plurality of modification configurations is related to a corresponding cell;
detecting that a mobility to a first cell among the multiple cells is triggered; and
applying a configuration of the first cell based on the mobility to the first cell being triggered,
wherein the configuration of the first cell is generated by applying a modification configuration for the first cell among the plurality of modification configurations on the reference configuration.

15. (canceled)

16. A network node comprising:
at least one transceiver;
at least one processor; and
at least one memory operatively coupled to the at least one processor and storing instructions that, based on being executed by the at least one processor, perform operations comprising:
generating a reference configuration for multiple cells and a plurality of modification configurations for the multiple cells, wherein each of the plurality of modification configurations is related to a corresponding cell; and
transmitting, to a user equipment (UE), the reference configuration and the plurality of modification configurations,
wherein the UE is configured to:
detect that a mobility to a first cell among the multiple cells is triggered; and apply a configuration of the first cell based on the mobility to the first cell being triggered, and
wherein the configuration of the first cell is generated by applying a modification configuration for the first cell among the plurality of modification configurations on the reference configuration.

17-20. (canceled)
